(19) United States
(12) Patent Application Publication
(10) Pub. No.: US 2017/0162069 A1
(43) Pub. Date: Jun. 8, 2017

(54) SCALABLE POPULATION HEALTH MANAGEMENT TOOLS FOR CLINICIANS

(71) Applicant: Noom, Inc., New York, NY (US)

(72) Inventors: Artem Petakov, New York, NY (US); Matthew Sonier, New York, NY (US); Logan Scott Merriam, New York, NY (US); Meghan Elisabeth Wood, New York, NY (US); Andreas Michaelides, Smithtown, NY (US); Mark Erik Simon, New York, NY (US); Vera Kern, New York, NY (US); Jelena Cvitanovic, Zagreb (HR); Ulysses Zheng, Vancouver (CA); Christos Avgerinos, Brooklyn, NY (US); Eddie Ng, Long Island City, NY (US); Thomas Patrick Joynt, Brooklyn, NY (US); Diana Louise Mackinnon, New York, NY (US); Elad Katz, New York, NY (US)

(21) Appl. No.: 14/956,754

(22) Filed: Dec. 2, 2015

(51) Int. Cl. G09B 5/12; G09B 19/00

(52) U.S. Cl. CPC G09B 5/12; G09B 19/0092

(57) ABSTRACT

A method of assisting an administrator in the management of users of a health and wellness system is disclosed. Input data is received from client devices of users of the health and wellness system. Levels of progress of each of the users toward meeting their health goals is determined based on the input data. Recommendations of actions for an administrator to perform are generated based on the determined levels of progress. The recommendations of the actions are ranked based on importance measurements associated with the recommendations. For each of the recommendations of the actions, if a confidence measurement corresponding to the importance measurement of the recommendation transgresses a confidence threshold, the recommendation is automatically processed on behalf of the administrator.

### TECHNICAL FIELD

The present disclosure generally relates to the field of health management tools and, in one specific example, to an automatically-adjustable algorithm and associated user interfaces for optimizing when a clinician or coach should intervene with respect to a monitored progress of a person toward meeting a health goal.

### BACKGROUND

Clinicians or health and wellness coaches may use online health and wellness systems to communicate with patients or clients or to monitor the progress of their patients or clients in reaching their health goals.

### BRIEF DESCRIPTION OF THE DRAWINGS

FIG. 1 is a network diagram depicting a client-server system within which various example embodiments may be deployed.

FIG. 2 is a block diagram illustrating example modules of the server application(s) of FIG. 1.

FIG. 3 is a flowchart illustrating example operations of a method of adjusting the scalable coaching algorithm of FIG. 2.

FIG. 4 is a flowchart of a method of communicating opportunities for intervention by an administrator for presentation in a user interface.

FIG. 5 is an example user interface for presenting opportunities for intervention by an administrator.

FIG. 6 is a block diagram of machine in the example form of a computer system within which instructions for causing the machine to perform any one or more of the operations or methodologies discussed herein may be executed.

### DETAILED DESCRIPTION

In the following description, for purposes of explanation, numerous specific details are set forth in order to provide an understanding of various embodiments of the present subject matter. It will be evident, however, to those skilled in the art that various embodiments may be practiced without these specific details.

Online health and wellness systems may receive input from users, including manual inputs entered by the users (e.g., manual logging of foods eaten, tasks or workouts completed, and so on) and automatic inputs received from devices of the users (e.g., GPS, accelerometer, or pedometer data, or any other sensor or device data). Such online systems may have many users (e.g., thousands, or tens of thousands, or more), including coaches, clinicians, patients, and others. These users may be automatically organized or may organize themselves into groups according to various factors, such as interests, geographic location, health goals, or health conditions. For example, users suffering from a particular health condition (e.g., those suffering from diabetes, heart problems, and so on) may be organized into wellness support groups that are designed to specifically address that health condition.

In various embodiments, each wellness support group has one or more administrators (e.g., a clinician or health and wellness coach) that facilitates the group. In various embodiments, an administrator is tasked with personally intervening when a level of progress of a group member suggests that the group member's health may be in danger. Additionally, the administrator may take a leadership role within the group, including posting public messages to the group or sending private messages to assist or encourage group members in achieving their health goals.

For example, administrator may monitor the progress of each group member in achieving periodic (e.g., daily, weekly, or monthly) tasks (e.g., such as tasks pertaining to exercise or diet), as well as the overall progress of each group member in achieving one or more health goals.

An administrator may post messages to the group, send private messages to individual members of the group, or take other actions to support group members. For example, the administrator may send or post a message congratulating group members upon completions of periodic tasks, warning group members of the consequences of not completing periodic tasks, encouraging users to complete periodic tasks, and so on.

In various embodiments, administrators may be tasked with managing several different wellness support groups. In fact, in various embodiments, the more people an administrator can manage, the more the costs associated with administration of the health and wellness system can be reduced.

In various embodiments, a scalable coaching algorithm may process input data received by the system and provide recommendations to administrators of actions to perform with respect to group members. The administrator may then parse through the recommendations and perform an action in response to the recommendation. The scalable coaching algorithm may then adjust importance measurements and confidence measurements pertaining to the recommendations. Over time, the confidence measurements associated with particular recommendations may transgress a confidence threshold and the actions associated with those recommendations may then be performed automatically by the system without input from the administrator. The administrator can also review and provide feedback to such automated responses to bolster or adjust confidence measurements. Thus, a continuous feedback process may be used to adjust confidence measurements and determine whether actions associated with recommendations should be performed automatically.

Regardless of whether an action is processed automatically on behalf of the administrator or manually by the administrator, the importance measurements and the confidence measurements associated with the importance measurements may be continually updated by the system based on the impact of the processing on the levels of progress of group members toward meeting their health goals, the impact of the processing on the success rate of the group members in achieving their health goals, or both.

Thus, in various embodiments, an action that an administrator chooses to take with respect to a user that is simply based on an intuition of the administrator may be automatically flagged by the system based on the importance measurement and the confidence measurement corresponding to the importance measurement. Such flagging may allow the administrator to reconsider an action before making it final.

In various embodiments, the importance measurement may be used to rank the suggestions of courses of action for the administrator to take with respect to each user. Thus, the administrator may be presented with a user interface in which recommended actions of users across different groups may be presented to the administrator for processing. However, the action taken by the administrator may nevertheless be performed within the context of the group to which the user belongs.

In various embodiments, a method of assisting an administrator in the management of users of a health and wellness system is disclosed. Input data is received from client devices of users of the health and wellness system. Levels of progress of each of the users toward meeting their health goals is determined based on the input data. Recommendations of actions for an administrator to perform are generated based on the determined levels of progress. The recommendations of the actions are ranked based on importance measurements associated with the recommendations. For each of the recommendations of the actions, if a confidence measurement corresponding to the importance measurement of the recommendation transgresses a confidence threshold, the recommendation is automatically processed on behalf of the administrator. The administrator can also review and provide feedback to such automated responses post de facto to bolster or adjust confidence measurements.

These methods and the various embodiments disclosed herein may be implemented as a computer system having one or more modules (e.g., hardware modules or software modules). These methods and the various embodiments disclosed herein may be embodied as instructions stored on a machine-readable medium that, when executed by a processor, cause the processor to perform operations pertaining to the methods.

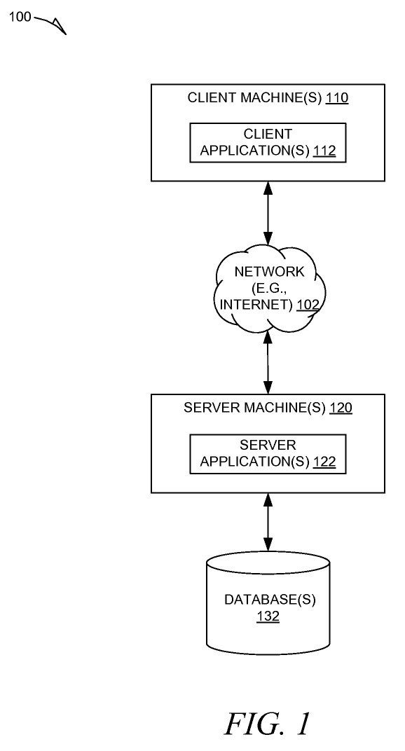

FIG. 1 is a network diagram depicting a system 100 (e.g., a wellness system), within which various example embodiments may be deployed. The system 100 includes server machine(s) 120. Server application(s) 122 in the server machine(s) 120 may provide server-side functionality (e.g., via a network 102) to one or more client application(s) 112 executing on one or more client machine(s) 110. Examples of the client machine(s) 110 may include mobile devices, including wearable computing devices. A mobile device may be any device that is portable or capable of being carried. Examples of mobile devices include a laptop computer, a tablet computer (e.g., an iPad), a mobile or smart phone (e.g., an iPhone), and so on. A wearable computing device may be any computing device that may be worn by a user. Examples of wearable computing devices include a smartwatch (e.g., a Pebble E-Paper Watch), an augmented reality head-mounted display (e.g., Google Glass), and so on. Such devices may use natural language recognition to support hands-free operation by a user.

In various embodiments, the client application(s) 112 may include a web browser (e.g., a browser, such as the Internet Explorer browser developed by Microsoft Corporation of Redmond, Washington), a native application (e.g., an application supported by an operating system of the device (e.g., one of client machine(s) 110), such as Android, Windows, or iOS), or other application. Each of the one or more client machine(s) 110 may include a module (e.g., a plug-in, add-in, or macro) that adds a specific service or feature to a larger system. In various embodiments, the network 102 includes one or more of the Internet, a Wide Area Network (WAN), or a Local Area Network (LAN).

Although not shown in FIG. 1, the server application(s) 122 may include an API server or a web server configured to provide programmatic and web interfaces, respectively, to one or more application servers. The application servers may host the one or more server application(s) 122. Additionally, the application server may, in turn, be coupled to one or more data services or database servers that facilitate access to one or more databases, NoSQL or non-relational data stores. Such databases or data stores may include database(s) 132. In various embodiments, the database(s) 132 include information provided by users of the wellness system or otherwise determined about users of the wellness system.

Such information may include information about meals users have eaten (e.g., based on logging of the meals by the users), tasks completed by users (e.g., exercise logged by the users or contents that users have read), unstructured interactions of the users with other users (e.g., in a support-group context), structured interactions of the users with other users (e.g., how many “high fives” a person has given or received), how consistently users have engaged in good habit-forming behaviors (e.g., how many meals in a row users have logged or how many meals users have logged today), attributes of the users (e.g., gender, age, height, weight, and so on), goals of the user (e.g., weight loss goals based on a starting weight and a target weight), preferences of the users (e.g., types of support groups the users are interested in joining or whether the users are interested in becoming facilitators of support groups), contact information (e.g., email addresses, home addresses, phone numbers, and so on), information users wish to share with other users, and so on.

The server application(s) 122 may provide a number of functions and services to users who access the server machine(s) 120. While the server application(s) 122 are shown in FIG. 1 to be included on the server machine(s) 120, in alternative embodiments, the server application(s) 210 may form part of a service that is separate and distinct from the server machine(s) 120.

Further, while the system 100 shown in FIG. 1 employs a client-server architecture, various embodiments are, of course, not limited to such an architecture, and could equally well find application in a distributed or peer-to-peer architecture system, for example. The various applications could also be implemented as standalone software programs, which do not necessarily have computer networking capabilities. Additionally, although not shown in FIG. 1, it will be readily apparent to one skilled in the art that client machine(s) 110 and server machine(s) 120 may be coupled to multiple additional networked systems.

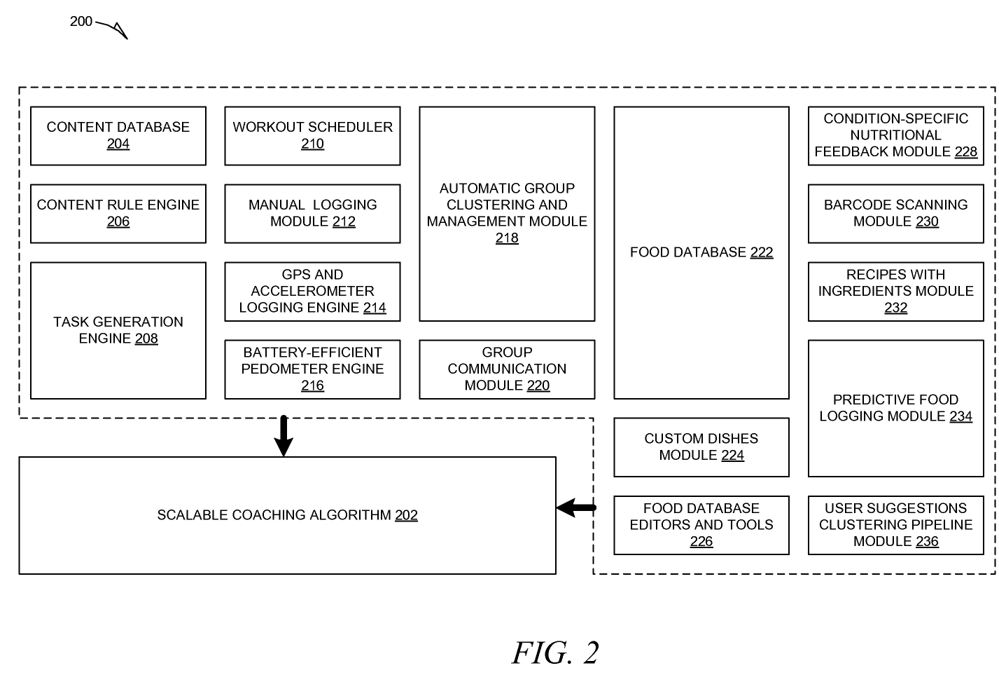

FIG. 2 is a block diagram illustrating example modules of the server application(s) 122. The example modules may provide input data to a scalable coaching algorithm 202. A content database 204 may include various content items that may be automatically selected and communicated for presentation on client devices of users of the health and wellness system. Such content items may include health information, motivational quotes, and so on. A content rule engine 206 may be configured to select content items for a particular user based on various factors, including information about the user. Such information may include a progress of the user toward meeting a health goal, profile information maintained by the user, periodic tasks that have been selected for the user to perform, and so on. A task generation engine 208 may be configured to automatically generate one or more periodic (e.g., daily, weekly, or monthly) tasks for the user to perform en route to achieving a health goal (e.g., a weight loss goal, a blood pressure goal, a medical or medication adherence goal, an exercise goal, and so on).

A workout scheduler 210 may be configured to automatically schedule one or more workouts for the user to perform (e.g., toward meeting an exercise goal). A manual logging 212 may be configured to receive manual logging of a progress of the user toward meeting a health goal, such as tasks completed by the user, food eaten by the user, or exercise performed by the user. A GPS and accelerometer logging engine 214 may automatically receive GPS or accelerometer data from a client device of the user and process the data in the context of the health and wellness system, monitoring the health of the user and the progress of the user toward meeting health goals, including exercise goals. Similarly, a battery-efficient pedometer engine 216 may automatically receive and process pedometer data from a pedometer of the user (e.g., via communication with a client device of the user to which the pedometer data is synchronized).

An automatic group clustering and management module 218 may be configured to automatically organize users of the health and wellness system into support groups. For example, in various embodiments, users may be automatically placed in a support group having a manageable size and specific to a health condition of the users, demographics of users, previous behavior of users, user attributes, and so on. In various embodiments, the automatic group clustering and management module 218 may assign one or more administrators (e.g., coaches or clinicians) to each support group.

A group communication module 220 may be configured to facilitate communication between members of each support group. For example, the group communication module 220 may allow users to publish their progress toward meeting their health goals for other members of the group to see. Additionally, the group communication module 220 may allow users to provide feedback or encouragement to each other to increase the likelihood that the group members will make progress toward meeting their health goals.

A food database 222 may include information pertaining to healthy foods and foods that users have consumed. A custom dishes module 224 may be configured to generate custom dishes for each user of the health and wellness system based on a determination of each user's health goal.

A food database editors and tools module 226 may provide one or more administrators or users with options to contribute to the food database (e.g., by providing ingredients for one or more custom dishes).

A condition-specific nutritional feedback module 228 may be configured to provide a user with nutritional feedback (e.g., based on a health condition of the user and information pertaining to foods that the user has consumed).

A barcode scanning module 230 may be configured to process the scanning of bar codes by a client device of a user (e.g., the client machine 110). In various embodiments, the processing may include classifying particular food items as having been purchased or consumed by the user.

A recipes with ingredients module 232 may be configured to provide one or more recipes, including ingredients for the recipes, to users based on various factors, including health conditions of the users and information pertaining to foods purchased or consumed by the users.

A predictive food logging module 234 may be configured to predict foods that a user is likely to have consumed during a time period and, for example, automatically log the predicted foods on behalf of the user or provide a list of predicted foods for optional selections to assist the user with manual logging tasks.

A user suggestions clustering pipeline module 236 may be configured to automatically generate one or more suggestions for the user pertaining to their progress toward meeting their health goals. For example, such suggestions may pertain to exercise, diet, or tasks that the user should perform to increase their chances of meeting their health goals. In various embodiments, the user suggestions clustering pipeline module 232 may be configured to cluster one or more related suggestions into a single communication that is to be transmitted to a client device of the user for presentation in a user interface of the client device.

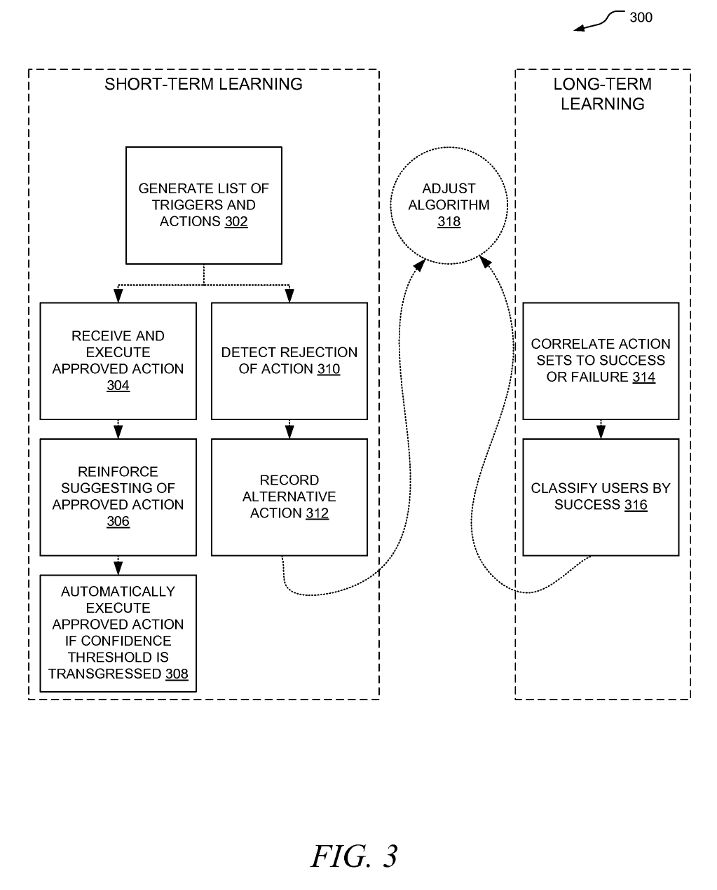

FIG. 3 is a flowchart illustrating example operations of a method 300 of adjusting the scalable coaching algorithm 202. In various embodiments of the method 300, operations are separated into operations for short-term learning based on human intuition and long-term learning based on compliance and outcomes. In various embodiments, the operations may be performed by the scalable coaching algorithm 202.

At operation 302, a list of recommendations of actions for an administrator to perform are generated. The recommended actions may be based on a determination that a trigger corresponds to the recommended action. Such triggers may include, for example, a success or a failure of a user with respect to completing a task, exercise goal, diet goal, and so on. Each of the recommendations may be based on importance measurements associated with the recommendations. In various embodiments, the importance measurements reflect an importance of the recommendation to the health of the user. For example, the failure of a person suffering from high blood pressure to complete a daily task of taking blood pressure medication may become more and more important (and the importance measure may be increased) based on a number of days on which the person has failed to complete the task. Additionally, the recommendation may be associated with a confidence measurement. In various embodiments, the confidence measure may be based on long-term compliance and outcomes associated with the recommendation as well as intuition of an administrator with respect to the recommendation.

At operation 304, it is determined that the administrator (e.g., a human coach) has approved and executed the recommendation. For example, if the recommended action is that the administrator follow up with the user via a personal communication (e.g., a phone call, instant message, or email message) and the administrator does, in fact, follow up using such a method, it may be determined that the administrator approved and executed the recommended action.

At operation 306, the confidence measurement associated with the recommended action may be increased to reflect the reinforcement by the administrator of the action as being the appropriate response for the trigger associated with the action.

At operation 308, the increased confidence measurement made be checked against a threshold confidence measurement to determine whether the action should be automatically executed in response to the next detection of the trigger with which the action is associated.

At operation 310, the confidence measurement associated with the recommended action may be decreased to reflect the administrator's choice to reject the action as being appropriate for the corresponding trigger. For example, if the recommended action is for the administrator to follow up with the user via a personal communication and the administrator elects to post a group message instead of initiate a personal communication, the confidence measurement associated with the personal communication in response to the trigger may be reduced.

At operation 312, an alternative action performed by the administrator may be identified and associated with the trigger. This new association may also be associated with a new initial confidence measurement.

At operation 314, the success or failure of a user to complete a task, exercise goal, diet goal, or overall health goal is monitored and used to adjust the confidence values for associations between triggers and actions. Thus, for example, if users who receive a personal communication in response to a particular trigger achieve a better health outcome in comparison to users who receive a group communication in response to the trigger, the confidence measure for the personal communication in that circumstance will be increased.

At operation 316, users are classified by success and the confidence measurements associated with trigger-action combinations of the most successful groups of users are increased.

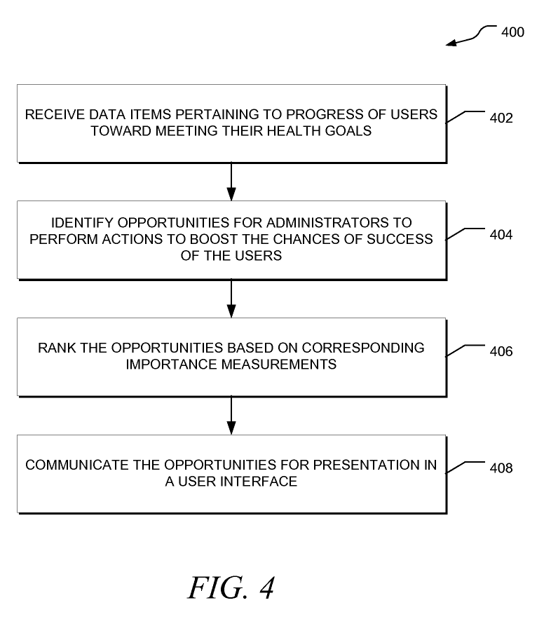

FIG. 4 is a flowchart illustrating example operations of a method 400 of generating recommendations for presentation in a user interface. In various embodiments, the operations may be performed by the scalable coaching algorithm 202.

At operation 402, data items pertaining to the progress of users toward meeting their health goals are received. For example, data items pertaining to the progress of users at completing periodic tasks, exercise goals, diet goals, and so on, are monitored based on data items received from any of the modules of FIG. 2, such as sensors on devices of the users and manual inputs provided by the users.

At operation 404, opportunities are identified for administrators to perform actions to boost the chances of success of the users. The opportunities may each be identified based on various factors, including an identification of a trigger for which an action by the administrator may affect an overall health outcome or prognosis of the user. Such triggers may include the success or failure of a user to make progress toward achieving a health goal. An action may be any action that the administrator has previously taken or may take in the future to increase the chances of the user making progress toward achieving the health goal. In various embodiments, the actions may include a particular type of a communication (e.g., an encouraging message or a warning message), a particular channel for the communication (e.g., a private message or a group message), and so on. Past trigger-action combinations selected by administrators as well as possible future trigger-action combinations may be stored in a table in a database. Each of the trigger-action combinations may be associated with confidence measurements and importance measurements, as described herein.

In various embodiments, trigger-action pairs may be ranked based on an importance measurement (e.g., how important it is for the health of the user for the user to perform an action in response to the trigger or how significant an intervention by the administrator in response to the trigger is likely to be in increasing the chances of the user in successfully achieving a health goal or sub-goal—that is, a confidence measurement).

At operation 406, the opportunities may be ranked based on their corresponding importance measurements. Thus, for example, it may be determined that the failure of a user to take certain medication over a certain time period is of higher importance than the failure of a user to complete a daily exercise task, such as walking for 30 minutes, on a particular day.

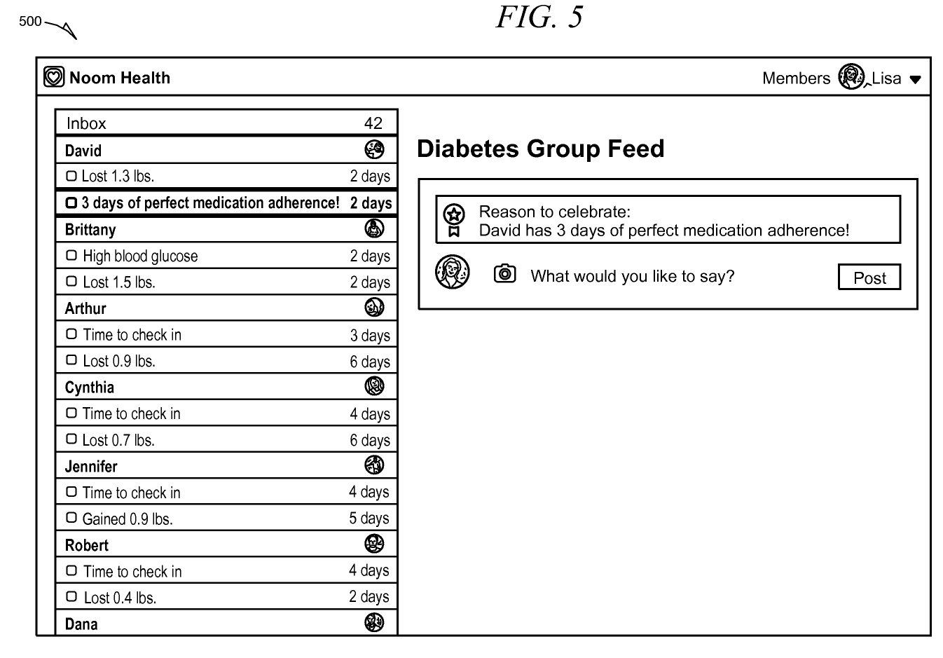

At operation 408, the opportunities are communicated to a device of an administrator for presentation in a user interface. An example of such a user interface is depicted in FIG. 5.

FIG. 5 is a block diagram illustrating an example user interface 500 for presenting recommendations to an administrator. In various embodiments, the recommendations are presented to the administrator in an inbox. The most important recommendation may be presented at the top of the inbox. For example, in this case, it may be determined based on an importance measurement assigned by the scalable coaching algorithm that a user David is associated with two triggers—he lost 1.3 pounds and he has had three days of perfect medication adherence. When a trigger is selected in the inbox, a recommended action may be presented to the administrator. Here, the second trigger for David has been selected in the inbox—three days of perfect medication adherence. The recommended action for the administrator is to post a celebratory message in the group feed for the Diabetes group to which David belongs. In other words, the scalable coaching algorithm has determined that this action by the administrator is the best action for the administrator to take to increase the chances of an overall positive health outcome for David in handling his diabetes condition. The administrator may take this action (e.g., by clicking the Post button). In response, the scalable coaching algorithm will increase the confidence measure for this trigger-action combination. On the other hand, if the administrator dismisses this action or performs another action, the scalable coaching algorithm will decrease the confidence measure for this trigger-action combination, as discussed above.

In various embodiments, the possible trigger-action combinations are grouped for each user and then ranked by user. Thus, in this case, the possible interventions for David by the administrator are considered to be most important to the overall success of the users managed by the administrator, followed by the possible interventions by the administrator for Brittany, Arthur, Cynthia, Jennifer, and Robert.

Here, the user interface presented to the administrator allows the administrator to view possible interventions independently of any groups to which the users belong or that the administrator manages. However, the actions presented may be specific to the user or the groups; thus, for example, the administrator may be provided with the option to post a message to a group that a particular member belongs to. Thus, the administrator may perform all interventions across all users and groups from a single user interface.

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the network 102) and via one or more appropriate interfaces (e.g., APIs).

Example embodiments may be implemented in digital electronic circuitry, or in computer hardware, firmware, software, or in combinations of them. Example embodiments may be implemented using a computer program product (e.g., a computer program tangibly embodied in an information carrier, in a machine-readable medium for execution by, or to control the operation of, data processing apparatus, such as, a programmable processor, a computer, or multiple computers).

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice.

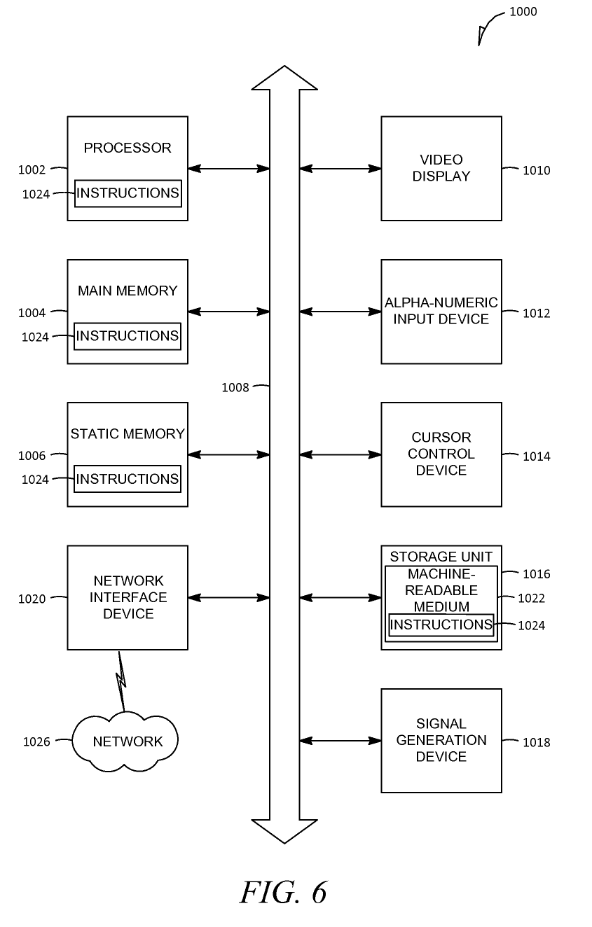

FIG. 6 is a block diagram of machine in the example form of a computer system 1000 within which instructions for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a mobile phone (e.g., an iPhone or a mobile phone executing an Android operating system), a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1000 includes a processor 1002 (e.g., a central processing unit (CPU), a graphics processing unit (GPU) or both), a main memory 1004 and a static memory 1006, which communicate with each other via a bus 1008. The computer system 1000 may further include a video display unit 1010 (e.g., a liquid crystal display (LCD) or a cathode ray tube (CRT)). The computer system 1000 also includes an alphanumeric input device 1012 (e.g., a keyboard), a user interface (UI) navigation (or cursor control) device 1014 (e.g., a mouse), a storage unit 1016 (e.g., a disk drive unit), a signal generation device 1018 (e.g., a speaker), and a network interface device 1020.

The storage unit 1016 includes a machine-readable medium 1022 on which is stored one or more sets of instructions and data structures (e.g., software) 1024 embodying or utilized by any one or more of the methodologies or functions described herein. The instructions 1024 may also reside, completely or at least partially, within the main memory 1004 or within the processor 1002 during execution thereof by the computer system 1000, the main memory 1004 and the processor 1002 also constituting machine-readable media. The instructions 1024 may also reside, completely or at least partially, within the static memory 1006.

While the machine-readable medium 1022 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present embodiments, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and compact disc-read-only memory (CD-ROM) and digital versatile disc (or digital video disc) read-only memory (DVD-ROM) disks.

Furthermore, the machine-readable medium is non-transitory in that it does not embody a propagating signal. However, labeling the tangible machine-readable medium as “non-transitory” should not be construed to mean that the medium is incapable of movement—the medium should be considered as being transportable from one physical location to another. Additionally, since the machine-readable medium is tangible, the medium may be considered to be a machine-readable device.

The instructions 1024 may further be transmitted or received over a communications network 1026 using a transmission medium. The instructions 1024 may be transmitted using the network interface device 1020 and any one of a number of well-known transfer protocols (e.g., HTTP). Examples of communication networks include a LAN, a WAN, the Internet, mobile telephone networks, POTS networks, and wireless data networks (e.g., WiFi and WiMax networks). The term “transmission medium” shall be taken to include any intangible medium capable of storing, encoding or carrying instructions for execution by the machine, and includes digital or analog communications signals or other intangible media to facilitate communication of such software. The network 1026 may be one of the networks 102.

Although an embodiment has been described with reference to specific example embodiments, it will be evident that various modifications and changes may be made to these embodiments without departing from the broader scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A system comprising:
one or more modules implemented by one or more computer processors, the one or more modules configured to, at least:
receive input data from client devices of users of a health and wellness system;
determine levels of progress of each of the users toward meeting their health goals based on the input data;
generate recommendations of actions for an administrator to perform based on the determined levels of progress;
rank the recommendations of the actions based on importance measurements associated with the recommendations; and
for each of the recommendations of the actions, if a confidence measurement corresponding to the importance measurement of the recommendation transgresses a confidence threshold, automatically process the recommendation on behalf of the administrator.

2. The system of claim 1, where the one or more modules are configured to determine the confidence measurement corresponding to the importance measurement based on previous instances of manual processing of similar recommendations by the administrator.

3. The system of claim 1, wherein the one or more modules are configured to, for each of the recommendations of the actions, if the confidence measurement corresponding to the importance measurement of the recommendation does not transgress the confidence threshold, notify the administrator to manually process the recommendation.

4. The system of claim 3, wherein the one or more modules are configured to adjust the confidence measurement based on changes to the levels of progress of the users after the automatic processing of the recommendation or manual processing of the recommendation.

5. The system of claim 4, wherein the processing of the recommendation includes posting a message in an online group associated with the user to incentivize the user to improve a level of progress of the user toward meeting a health goal of the user.

6. The system of claim 4, wherein the processing of the recommendation includes sending an electronic communication to the user, the electronic communication including information pertaining to the importance measurement and a level of progress of the user toward meeting a health goal of the user.

7. The system of claim 1, wherein the one or more modules are configured to determine the importance measurement based on a combination of a level of progress of the user toward meeting a health goal of the user and a known health condition of the user.

8. A method comprising:
receiving input data from client devices of users of a health and wellness system;
determining levels of progress of each of the users toward meeting their health goals based on the input data;
generating recommendations of actions for an administrator to perform based on the determined levels of progress;
ranking the recommendations of the actions based on importance measurements associated with the recommendations; and
for each of the recommendations of the actions, if a confidence measurement corresponding to the importance measurement of the recommendation transgresses a confidence threshold, using a computer processor to automatically process the recommendation on behalf of the administrator.

9. The method of claim 8, further comprising determining the confidence measurement corresponding to the importance measurement based on previous instances of manual processing of similar recommendations by the administrator.

10. The method of claim 8, further comprising, for each of the recommendations of the actions, if the confidence measurement corresponding to the importance measurement of the recommendation does not transgress the confidence threshold, notifying the administrator to manually process the recommendation.

11. The method of claim 10, further comprising adjusting the confidence measurement based on changes to the levels of progress of the users after the automatic processing of the recommendation or manual processing of the recommendation.

12. The method of claim 11, wherein the processing of the recommendation includes posting a message in an online group associated with the user to incentivize the user to improve a level of progress of the user toward meeting a health goal of the user.

13. The method of claim 11, wherein the processing of the recommendation includes sending an electronic communication to the user, the electronic communication including information pertaining to the importance measurement and a level of progress of the user toward meeting a health goal of the user.

14. The method of claim 8, further comprising determining the importance measurement based on a combination of a level of progress of the user toward meeting a health goal of the user and a known health condition of the user.

15. A non-transitory machine readable storage medium storing a set of instructions that, when executed by at least one processor of a machine, cause the machine to perform operations comprising:
receiving input data from client devices of users of a health and wellness system;
determining levels of progress of each of the users toward meeting their health goals based on the input data;
generating recommendations of actions for an administrator to perform based on the determined levels of progress;
ranking the recommendations of the actions based on importance measurements associated with the recommendations; and
for each of the recommendations of the actions, if a confidence measurement corresponding to the importance measurement of the recommendation transgresses a confidence threshold, automatically processing the recommendation on behalf of the administrator.

16. The non-transitory machine readable storage medium of claim 15, further comprising determining the confidence measurement corresponding to the importance measurement based on previous instances of manual processing of similar recommendations by the administrator.

17. The non-transitory machine readable storage medium of claim 15, further comprising, for each of the recommendations of the actions, if the confidence measurement corresponding to the importance measurement of the recommendation does not transgress the confidence threshold, notifying the administrator to manually process the recommendation.

18. The non-transitory machine readable storage medium of claim 17, further comprising adjusting the confidence measurement based on changes to the levels of progress of the users after the automatic processing of the recommendation or manual processing of the recommendation.

19. The non-transitory machine readable storage medium of claim 18, wherein the processing of the recommendation includes posting a message in an online group associated with the user to incentivize the user to improve a level of progress of the user toward meeting a health goal of the user.

20. The non-transitory machine readable storage medium of claim 18, wherein the processing of the recommendation includes sending an electronic communication to the user, the electronic communication including information pertaining to the importance measurement and a level of progress of the user toward meeting a health goal of the user.
